(19) United States
(12) Patent Application Publication
(10) Pub. No.: US 2026/0121116 A1
(43) Pub. Date: Apr. 30, 2026

(54) POLYMER ELECTROLYTE MEMBRANE FOR LITHIUM SECONDARY BATTERY AND LITHIUM SECONDARY BATTERY INCLUDING THE SAME

(71) Applicants: SK ON CO., LTD., Seoul (KR); INDUSTRY-ACADEMIC COOPERATION FOUNDATION GYEONGSANG NATIONAL UNIVERSITY, Gyeongsangnam-do (KR)

(72) Inventors: Han Sol LEE, Daejeon (KR); Myung Soo PARK, Daejeon (KR); Ki Hyun KIM, Gyeonggi-do (KR); Yu Gyeong JEONG, Gyeongsangnam-do (KR); Soon Sik HWANG, Gyeongsangnam-do (KR); Yu Eun KIM, Gyeongsangnam-do (KR)

(21) Appl. No.: 19/373,748

(22) Filed: Oct. 30, 2025

(30) Foreign Application Priority Data
Oct. 30, 2024 (KR) 10-2024-0150299
Oct. 29, 2025 (KR) 10-2025-0159598

(51) Int. Cl. H01M 10/0565; H01M 10/052; H01M 50/42; H01M 50/426; H01M 50/497

(52) U.S. Cl. CPC H01M 10/0565; H01M 10/052; H01M 50/42; H01M 50/426; H01M 50/497; H01M 2300/0082

(57) ABSTRACT

A polymer electrolyte membrane for a lithium secondary battery according to the present disclosure includes a copolymer. The copolymer include a main chain including a first repeating unit and a second repeating unit, a fluoroalkyl group bonded as a side chain to the main chain, and a polymer segment bonded as a side chain to the main chain and containing oxygen. A lithium secondary battery according to the present disclosure includes the polymer electrolyte membrane for a lithium secondary battery.

### CROSS-REFERENCE TO RELATED APPLICATION AND CLAIM OF PRIORITY

This application claims priority to Korean Patent Application No. 10-2024-0150299 filed on Oct. 30, 2024 and No. 10-2025-0159598 filed on Oct. 29, 2025 in the Korean Intellectual Property Office (KIPO), the entire disclosure of which is incorporated by reference herein.

### BACKGROUND

### 1. Field of the Invention

The present disclosure relates to a polymer electrolyte membrane for a lithium secondary battery and a lithium secondary battery including the same.

### 2. Description of the Related Art

Secondary batteries are batteries that can be repeatedly charged and discharged. With the development of information and communication and display industries, they have been widely applied as power sources for portable electronic communication devices, such as camcorders, mobile phones, and laptop PCs. In addition, battery packs including secondary batteries have recently been developed and applied as power sources for eco-friendly vehicles, such as electric vehicles.

Among secondary batteries, lithium secondary batteries are actively being researched and developed due to their high operating voltage, high energy density per unit weight, and advantages in charging speed and weight reduction.

Recently, lithium secondary batteries having high energy density and rapid charging characteristics are being researched and developed. However, heat may build up within the battery during repeated charging and discharging thereby causing a fire.

The fire safety of batteries may be improved by using solid or semi-solid electrolytes. Solid or semi-solid electrolytes may exhibit less fluidity and thermal deformation than liquid electrolytes, thereby improving battery safety.

However, in order to increase the capacity and size of the battery, structural modification, processing and improvement of the physical properties of the electrolyte layer may be necessary to improve the cycle life characteristics and stability of the lithium battery.

### SUMMARY

An object of the present disclosure is to provide a polymer electrolyte membrane for a lithium secondary battery having improved electrochemical properties.

Another object of the present disclosure is to provide a lithium secondary battery including the polymer electrolyte membrane for a lithium secondary battery.

A polymer electrolyte membrane for a lithium secondary battery according to exemplary embodiments of the present disclosure includes a copolymer, The copolymer includes: a main chain including a first repeating unit represented by Formula 1 below and a second repeating unit represented by Formula 2 below; a fluoroalkyl group bonded as a side chain to the main chain; and a polymer segment bonded as a side chain to the main chain and containing oxygen.

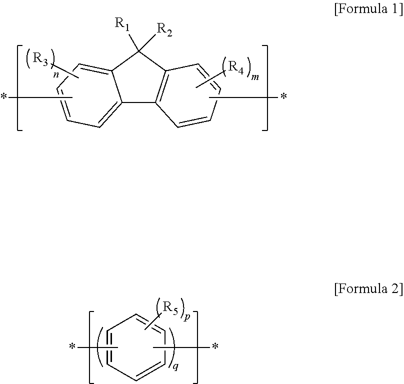

In Formulas 1 and 2, R₁ and R₂ are each independently hydrogen or an alkyl group having 1 to 10 carbon atoms, R₃ to R₅ are each independently hydrogen, an alkyl group having 1 to 60 carbon atoms, an alkenyl group having 2 to 60 carbon atoms, an alkynyl group having 2 to 60 carbon atoms, or an arylthioxy group having 6 to 60 carbon atoms, n, m and p are each independently 0 or an integer from 1 to 4, q is an integer from 2 to 4, and * represents a bonding site.

In exemplary embodiments, Formula 1 may be represented by Formula 1-1 below:

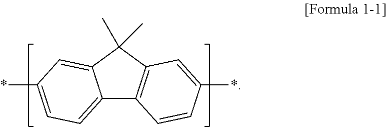

In exemplary embodiments, the Formula 2 may be represented by Formula 2-1 or 2-2 below:

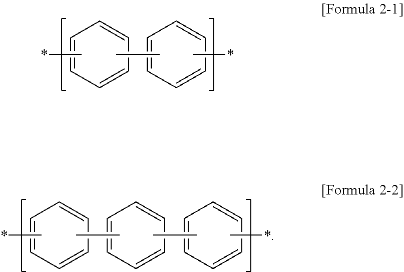

In exemplary embodiments, the ratio of the number of the second repeating units to the number of the first repeating units may be 0.1 to 10.

In exemplary embodiments, the fluoroalkyl group may have a structure in which at least one of the hydrogen atoms of the alkyl group having 1 to 10 carbon atoms is substituted with fluorine.

In exemplary embodiments, the fluoroalkyl group may include at least one selected from the group consisting of a trifluoromethyl group, a pentafluoroethyl group, a trifluoroethyl group, and a heptafluoropropyl group.

In exemplary embodiments, the fluoroalkyl group may be directly bonded to the main chain.

In exemplary embodiments, the polymer segment may include a polyether segment or a poly(meth)acrylate segment.

In exemplary embodiments, the polyether segment may be represented by Formula 3 below:

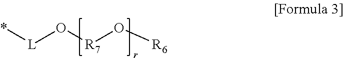

In Formula 3, L is a direct bond or an alkylene group having 1 to 10 carbon atoms, R₆ is an alkyl group having 1 to 10 carbon atoms, R₇ is an alkylene group having 1 to 10 carbon atoms, r is an integer from 5 to 20, and * may represent a bonding site to the main chain.

In exemplary embodiments, the main chain may include a third repeating unit represented by Formula 4 below:

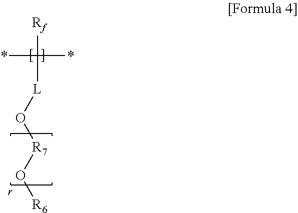

In Formula 4, R_{f} is a fluoroalkyl group having 1 to 10 carbon atoms, L is a direct bond or an alkylene group having 1 to 10 carbon atoms, R₆ is an alkyl group having 1 to 10 carbon atoms, R₇ is an alkylene group having 1 to 10 carbon atoms, r is an integer from 5 to 20, and * may represent a bonding site.

In exemplary embodiments, the copolymer may have a weight average molecular weight of 10 kg/mol to 400 kg/mol.

In exemplary embodiments, the polymer electrolyte membrane may have a thickness of 20 μm to 100 μm.

In exemplary embodiments, the polymer electrolyte membrane may have anionic conductivity of 0.2×10⁻⁶ S/cm to 100×10⁻⁶ S/cm.

In exemplary embodiments, the polymer electrolyte membrane for a lithium secondary battery may include a lithium salt, and the content of the lithium salt may be 50% by weight to 90% by weight, based on the total weight of the polymer electrolyte membrane for a lithium secondary battery.

A lithium secondary battery according to exemplary embodiments of the present disclosure includes: a cathode; an anode disposed opposite to the cathode; and the polymer electrolyte membrane for a lithium secondary battery disposed between the cathode and the anode.

The polymer electrolyte membrane for a lithium secondary battery according to exemplary embodiments of the present disclosure may include a copolymer having a high molecular weight. Accordingly, the durability of the polymer electrolyte membrane for a lithium secondary battery may be improved.

The copolymer of the polymer electrolyte membrane for a lithium secondary battery may include an oxygen-containing polymer segment capable of interacting with lithium ions. Accordingly, the ionic conductivity and electrochemical stability of the polymer electrolyte membrane for a lithium secondary battery may be improved, and the degree of dissociation of a lithium salt in the polymer electrolyte membrane for a lithium secondary battery may be enhanced.

The copolymer of the polymer electrolyte membrane for a lithium secondary battery may include a polymer segment as a side chain. Accordingly, the copolymer chain may have increased bending and rotational flexibility, and reduced crystallinity, thereby further improving the ionic conductivity of the polymer electrolyte membrane for a lithium secondary battery.

Lithium secondary batteries according to exemplary embodiments of the present disclosure may have improved rate characteristics.

### BRIEF DESCRIPTION OF THE DRAWINGS

The above and other objects, features and other advantages of the present disclosure will be more clearly understood from the following detailed description taken in conjunction with the accompanying drawings, in which:

FIGS. 1 and 2 are graphs showing ¹H-NMR results of the copolymers of Synthesis Examples 2 and 1, respectively;

FIG. 3 is a graph showing the Fourier transform infrared (FT-IR) analysis results of the copolymers of Synthesis Examples 1 and 2;

FIG. 4 is a graph showing the DSC analysis results of the copolymers of Synthesis Examples 1 and 2;

FIG. 5 is a graph showing the strain-stress curves of the copolymers of Synthesis Examples 1 and 2;

FIG. 6 is a graph showing the TGA analysis results of the polymer electrolyte membranes of Examples 1 to 4; and

FIG. 7 is a graph showing the electrochemical impedance spectroscopy (EIS) results of the polymer electrolyte membranes of Examples 1 to 4.

### DETAILED DESCRIPTION

The present disclosure provides a polymer electrolyte membrane for a lithium secondary battery that includes a copolymer having an oxygen-containing polymer segment bonded as a side chain to a main chain. The present disclosure also provides a lithium secondary battery including the polymer electrolyte membrane for a lithium secondary battery.

Hereinafter, embodiments of the present disclosure will be described in detail with reference to the accompanying drawings. However, these are merely illustrative and the present disclosure is not limited to the specific embodiments described as examples.

The polymer electrolyte membrane for a lithium secondary battery according to exemplary embodiments (hereinafter, also abbreviated as “polymer electrolyte membrane”) may include a copolymer having a main chain including a first repeating unit and a second repeating unit.

The first repeating unit may be represented by Formula 1 below.

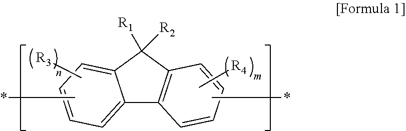

In Formula 1, R₁ and R₂ are each independently hydrogen or an alkyl group having 1 to 10 carbon atoms. In some embodiments, R₁ and R₂ may each independently be hydrogen or an alkyl group having 1 to 3 carbon atoms. For example, R₁ and R₂ may each be a methyl group.

The first repeating unit may include a fluorenyl moiety. Accordingly, the free volume between copolymer chains may increase, and the rate at which the crystallinity of the copolymer increases may be reduced. As a result, the copolymer may achieve a high molecular weight, and the durability of the polymer electrolyte membrane may be improved.

In Formula 1, R₃ and R₄ may each independently be hydrogen, an alkyl group having 1 to 60 carbon atoms, an alkenyl group having 2 to 60 carbon atoms, an alkynyl group having 2 to 60 carbon atoms, or an arylthioxy group having 6 to 60 carbon atoms. For example, R₃ and R₄ may each independently be hydrogen or an alkyl group having 1 to 5 carbon atoms.

In Formula 1, n and m may each independently be 0 or an integer from 1 to 4. For example, n and m may each independently be 0 or 1.

In Formula 1, * represents a bonding site. Repeating units such as Formula 2 or Formula 3 described below may be bonded to the bonding site.

According to exemplary embodiments, Formula 1 may be represented by Formula 1-1 below.

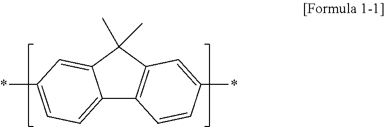

The second repeating unit may be represented by Formula 2 below.

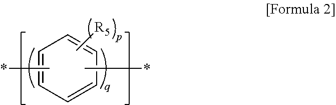

In Formula 2, R₅ may be hydrogen, an alkyl group having 1 to 60 carbon atoms, an alkenyl group having 2 to 60 carbon atoms, an alkynyl group having 2 to 60 carbon atoms, or an arylthioxy group having 6 to 60 carbon atoms. For example, R₅ may be hydrogen or an alkyl group having 1 to 5 carbon atoms.

In Formula 2, p may be 0 or an integer from 1 to 4. For example, p may be 0 or 1.

In Formula 2, q may be an integer from 2 to 4. For example, q may be 2 or 3.

In Formula 2, * represents a bonding site. Repeating units such as Formula 1 described above or Formula 3 described below may be bonded to the bonding site.

According to exemplary embodiments, Formula 2 may be represented by Formula 2-1 or 2-2 below.

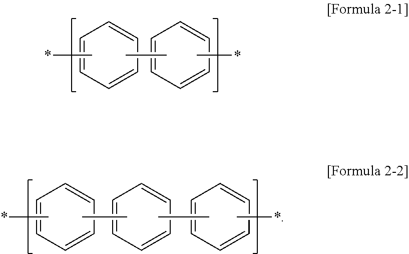

The second repeating unit may include a biphenyl moiety or a terphenyl moiety. Accordingly, the copolymer chain may rotate, thereby improving the formability of the polymer electrolyte membrane.

According to exemplary embodiments, the ratio of the number of the second repeating units to the number of the first repeating units may be 0.1 to 10. According to some embodiments, the ratio of the number of the second repeating units to the number of the first repeating units may be 1 to 10, or 4 to 9.

Within the above range, the polymer electrolyte membrane may be formed, and durability of the the polymer electrolyte membrane may be improved.

According to exemplary embodiments, the copolymer may have a fluoroalkyl group and a polymer segment bonded as a side chain to the main chain. The polymer segment may include oxygen and, by being bonded as a side chain to the main chain, may promote the dissociation of a lithium salt included in the polymer electrolyte membrane. In addition, the polymer segment containing oxygen may actively interact with lithium ions, thereby improving the ionic conductivity and electrochemical stability of the polymer electrolyte membrane.

According to exemplary embodiments, the fluoroalkyl group may have a structure in which at least one of the hydrogen atoms of the alkyl group having 1 to 10 carbon atoms is substituted with fluorine. For example, the fluoroalkyl group may have a structure in which one or more or all of the hydrogen atoms of the alkyl group having 1 to 10 carbon atoms are substituted with fluorine.

For example, the fluoroalkyl group may include a trifluoromethyl group, a pentafluoroethyl group, a trifluoroethyl group, a heptafluoropropyl group or the like. In particular, the fluoroalkyl group may include a trifluoromethyl group.

According to exemplary embodiments, the fluoroalkyl group may be directly bonded to the main chain. For example, a carbon atom of the fluoroalkyl group may be directly bonded to a carbon atom of the main chain.

According to exemplary embodiments, the polymer segment may be bonded to the main chain via a linker. The term “linker” refers to a divalent organic group, one end of which is bonded to the polymer segment and the other end is bonded to the main chain, thereby linking the polymer segment to the main chain.

According to exemplary embodiments, the polymer segment may include a polyether segment or a poly(meth)acrylate segment. The polymer segment may include at least one oxygen atom, thereby exhibiting high polarity and increasing the degree of dissociation of the lithium salt.

According to exemplary embodiments, the polyether segment may be represented by Formula 3 below.

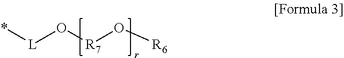

In Formula 3, L may be a direct bond or an alkylene group having 1 to 10 carbon atoms. In some embodiments, L may be an alkylene group having 2 to 5 carbon atoms, and for example, L may be a propylene group.

In Formula 3, R₆ may be an alkyl group having 1 to 10 carbon atoms. In some embodiments, R₆ may be an alkyl group having 1 to 5 carbon atoms. For example, R₆ may be a methyl group.

In Formula 3, R₇ may be an alkylene group having 1 to 10 carbon atoms. In some embodiments, R₇ may be an alkylene group having 1 to 5 carbon atoms, and for example, R₇ may be an ethylene group.

In Formula 3, r may be an integer from 5 to 20. In some embodiments, r may be an integer from 5 to 10.

In Formula 3, * may represent a bonding site to the main chain.

In exemplary embodiments, the fluoroalkyl group and the polymer segment may be bonded to a single carbon atom. In some embodiments, the main chain may include a third repeating unit represented by Formula 4 below.

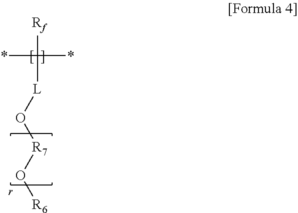

In Formula 4, R_{f} may be a fluoroalkyl group having 1 to 10 carbon atoms. The fluoroalkyl group may be the same as described above.

In Formula 4, L, R₆, R₇ and r may be the same as described in Formula 3.

In Formula 4, * represents a bonding site. Repeating units such as Formula 1 or Formula 2 may be bonded to the bonding site.

According to exemplary embodiments, the third repeating unit may be positioned between the first repeating units, between the second repeating units, and/or between the first repeating unit and the second repeating unit. For example, the third repeating unit may be positioned between the first repeating unit and/or the second repeating units.

According to exemplary embodiments, the content of the first repeating unit, based on the total molar amount of the first, second and third repeating units, may be 3 mol % to 20 mol %. According to some embodiments, the content of the first repeating unit, based on the total molar amount of the first, second and third repeating units, may be 4 mol % to 10 mol %.

According to exemplary embodiments, the content of the second repeating unit, based on the total molar amount of the first, second and third repeating units, may be 30 mol % to 50 mol %. According to some embodiments, the content of the second repeating unit, based on the total molar amount of the first, second and third repeating units, may be 35 mol % to 45 mol %.

According to exemplary embodiments, the content of the third repeating unit, based on the total molar amount of the first, second and third repeating units, may be 30 mol % to 70 mol %. According to some embodiments, the content of the third repeating unit, based on the total molar amount of the first, second and third repeating units, may be 40 mol % to 60 mol %, or 45 mol % to 55 mol %.

Within the above range, both the durability and flexibility of the polymer electrolyte membrane may be improved.

According to exemplary embodiments, the copolymer may have a weight average molecular weight of 10 kg/mol to 400 kg/mol. According to some embodiments, the weight average molecular weight of the copolymer may be 20 kg/mol to 400 kg/mol. Within this range, the mechanical properties of the polymer electrolyte membrane may be further improved.

According to exemplary embodiments, the polymer electrolyte membrane may have a thickness of 20 μm to 100 μm. In some embodiments, the thickness of the polymer electrolyte membrane may be 25 μm to 70 μm.

According to exemplary embodiments, the polymer electrolyte membrane may have an ionic conductivity of 0.2×10⁻⁶ S/cm to 100×10⁻⁶ S/cm. According to some embodiments, the ionic conductivity of the polymer electrolyte membrane may be 0.5×10⁻⁶ S/cm to 5×10⁻⁶ S/cm. Within this range, the rate characteristics of a lithium secondary battery including the polymer electrolyte membrane may be improved.

The copolymer may be prepared by introducing a polymer segment into a prepolymer produced from a monomer mixture including a fluorene-based monomer, a multiphenyl-based monomer, and a fluoroalkyl ketone-based monomer.

The fluorene-based monomer may be represented by Formula 5 below.

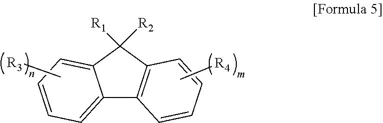

The above fluorene-based monomer may be a dialkyl fluorine, and may be represented by Formula 5-1 below.

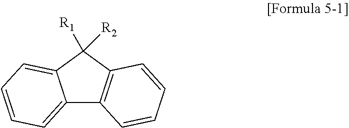

In Formula 5 and Formula 5-1, R₁ to R₄, n and m may be the same as described in Formula 1.

For example, the fluorene-based monomer may be dimethylfluorene.

The multiphenyl-based monomer may be represented by Formula 6 below.

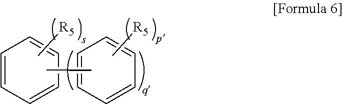

In Formula 6, q′ may be 1 or 2, p′ may be 0 or an integer from 1 to 4, R₅ may be the same as described in Formula 2, and s may be 0 or an integer from 1 to 4.

The multiphenyl-based monomer may be represented by Formula 6-1 or Formula 6-2 below.

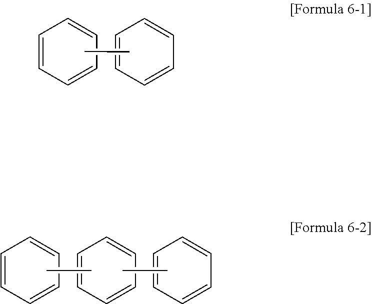

For example, the multiphenyl-based monomer may be biphenyl.

The fluoroalkyl ketone-based monomer may be represented by Formula 7 below.

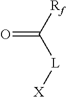

In Formula 7, R_{f} and L are the same as described in Formula 4, and X may be a halogen. For example, X may be Cl, F, Br, etc.

According to exemplary embodiments, the content of the fluorene-based monomer, based on the total molar amount of the fluorene-based monomer, the multiphenyl-based monomer and the fluoroalkyl ketone-based monomer, may be 3 mol % to 20 mol %. According to some embodiments, the content of the fluorene-based monomer, based on the total molar amount of the fluorene-based monomer, the multiphenyl-based monomer and the fluoroalkyl ketone-based monomer, may be 4 mol % to 10 mol %.

According to exemplary embodiments, the content of the multiphenyl-based monomer, based on the total molar amount of the fluorene-based monomer, the multiphenyl-based monomer and the fluoroalkyl ketone-based monomer, may be 30 mol % to 50 mol %. According to some embodiments, the content of the multiphenyl-based monomer, based on the total molar amount of the fluorene-based monomer, the multiphenyl-based monomer and the fluoroalkyl ketone-based monomer, may be 35 mol % to 45 mol %.

According to exemplary embodiments, the content of the fluoroalkyl ketone-based monomer, based on the total molar amount of the fluorene-based monomer, the multiphenyl-based monomer and the fluoroalkyl ketone-based monomer, may be 30 mol % to 70 mol %. According to some embodiments, the content of the fluoroalkyl ketone-based monomer, based on the total molar amount of the fluorene-based monomer, the multiphenyl-based monomer and the fluoroalkyl ketone-based monomer, may be 40 mol % to 60 mol %, or 45 mol % to 55 mol %.

The monomer mixture may further include a solvent. The content of the solvent may be 10 parts by weight to 40 parts by weight, based on 100 parts by weight of the total of the fluorene-based monomer, the multiphenyl-based monomer and the fluoroalkyl ketone-based monomer.

For example, the solvent may include dichloromethane.

The monomer mixture may react in the presence of a catalyst to form a prepolymer. The catalyst is not particularly limited, but an acidic catalyst such as trifluoromethanesulfonic acid may be used.

The monomer mixture may be stabilized at a relatively low temperature before the reaction.

For example, the monomer mixture may be allowed to stand at a temperature of 0° C. to 15° C. for about 10 to 60 minutes to stabilize. After stabilization, the monomer mixture may be allowed to stand at 20° C. to 40° C. for about 3 to 5 hours to form the prepolymer.

The prepolymer may be obtained by precipitating and drying a dispersion including the prepolymer, unreacted monomers, and the solvent.

The copolymer may be prepared by introducing a polymer segment containing oxygen into the prepolymer. The copolymer may be prepared by reacting the prepolymer with a nitrogen-containing compound.

For example, the polymer containing oxygen may be a polyether, poly(meth)acrylate, or the like.

The polymer containing oxygen may be used in larger amount than the prepolymer. For example, the ratio of the weight of the polymer containing oxygen to the weight of the prepolymer may be 2 to 5.

The prepolymer and the polymer containing oxygen may react in the presence of a catalyst. The catalyst is not particularly limited, but may be a basic catalyst such as sodium hydroxide.

The reaction solution containing the prepolymer and the polymer containing oxygen may further include a solvent. The content of the solvent may be 10 to 40 parts by weight, based on 100 parts by weight of total prepolymer and the polymer containing oxygen.

The solvent may include, for example, dimethylacetamide.

The reaction solution may be stabilized at a relatively low temperature before the reaction.

For example, the reaction solution may be allowed to stand at about 60° C. to 90° C. for 30 to 90 minutes to stabilize. After stabilization, the reaction solution may be allowed to stand at about 100° C. to 150° C. for 2 to 5 hours to form the copolymer.

The copolymer may be obtained by precipitating and drying a dispersion including the copolymer, unreacted monomers, and the solvent.

The method for preparing the copolymer is exemplary, and is not particularly limited as long as it can form a copolymer having the above-described structure.

In exemplary embodiments, the polymer electrolyte membrane may further include a lithium salt. The lithium salt is a component directly involved in the current flow of the lithium secondary battery and may include lithium cations and organic or inorganic anions.

In exemplary embodiments, the content of the lithium salt may be 50 to 90%/o by weight (“wt %”), based on the total weight of the polymer electrolyte membrane. According to some embodiments, the content of the lithium salt may be 50 wt % to 80 wt %, or 60 wt % to 70 wt %, based on the total weight of the polymer electrolyte membrane.

Within the above range, the lithium ion conductivity of the polymer electrolyte membrane may be further improved. In addition, the rate characteristics of a lithium secondary battery including the polymer electrolyte membrane may be further enhanced.

The lithium salt is not particularly limited, but may be represented by Li⁺X⁻. As an anion (X⁻) of the lithium salt, F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃—, CF₃CF₂SO₃⁻, (CF₃SO₂)₂N⁻, (FSO₂)₂N⁻, CF₃CF₂(CF₃)₂CO⁻, (CF₃SO₂)CH⁻, (SF₅)₃C⁻, (CF₃SO₂C⁻, CF₃(CF₂)₇SO₃⁻, CF₃CO₂⁻, CH₃CO₂⁻, SCN⁻, and (CF₃CF₂SO₂)₂N⁻, etc. may be exemplified.

For example, the lithium salt may be Li(FSO₂)₂N, which is lithium bisfluorosulfonylimide (LiFSI).

According to exemplary embodiments, the polymer electrolyte membrane may further include an electrolyte additive, an inorganic solid electrolyte, an organic solid electrolyte or the like.

For example, the electrolyte additive may include an unsaturated carbonate compound, a fluorine-substituted carbonate compound, a sultone compound, a cyclic sulfate compound, a cyclic sulfite compound, a phosphate compound, a borate compound or the like.

The unsaturated carbonate compound may include vinylene carbonate (VC), vinyl ethylene carbonate (VEC), etc.

The fluorine-substituted carbonate compound may include fluoroethylene carbonate (FEC), etc.

The sultone compound may include 1,3-propane sultone, 1,3-propene sultone, 1,4-butane sultone, etc.

The cyclic sulfate compound may include 1,2-ethylene sulfate, 1,2-propylene sulfate, etc.

The cyclic sulfite compound may include ethylene sulfite, butylene sulfite, etc.

The phosphate compound may include lithium difluoro bis(oxalato) phosphate, lithium difluorophosphate, etc.

The borate compound may include lithium bis(oxalate)borate, etc.

The inorganic solid electrolyte may include a sulfide-based solid electrolyte or an oxide-based solid electrolyte.

The sulfide-based solid electrolyte is Li₂S—P₂S₅, Li₂S—P₂S₅—LiCl, Li₂S—P₂S₅—LiBr, Li₂S—P₂S₅—LiCl—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅-ZmSn (m and n are positive numbers, Z is Ge, Zn or Ga), Li₂S—GeS₂, Li₂S—SiS₂—Li₃PO₄, Li₂S—SiS₂—LiₚMO_{q}, (p and q are positive numbers, M is P, Si, Ge, B, Al, Ga or In), Li₇₋ₓPS₆₋ₓClₓ (0≤x≤2), Li₇₋ₓPS₆₋ₓBrₓ (0≤x≤2), Li₇₋ₓPS₆₋ₓIₓ (0≤x≤2), etc. These may be used alone or in combination of two or more thereof.

The oxide-based solid electrolyte may include a garnet compound (e.g., LLZO), a NASICON compound, a perovskite compound, etc.

The LLZO compound may be an oxide including lithium, lanthanum, and zirconium. The LLZO compound may further include Al, Ga, In, Sc, Ba or Nb or the like. For example, it may include Li₇La₃Zr₂O₁₂, etc.

The NASICON compound may be a compound having a NASICON crystal structure or a NASICON-like crystal structure, and may include, for example, a LATP compound or a LAGP compound.

The LATP compound may be a phosphate including lithium, aluminum, and titanium. For example, it may include Li_{1.3}Al_{0.3}Ti_{1.7}(PO₄)₃, etc.

The LAGP compound may be a phosphate including lithium, aluminum, and germanium. For example, it may include Li_{1.5}Al_{0.5}Ge_{1.5}(PO₄)₃, etc.

The perovskite compound may include an LLTO compound having a perovskite crystal structure or a perovskite-like crystal structure.

The LLTO compound may be an oxide including lithium, lanthanum, and titanium. For example, it may include Li_{1.5}La_{0.5}TiO₃, etc.

The polymer electrolyte membrane may be formed from a composition including the copolymer, the lithium salt, and a solvent.

In the composition, the content of the lithium salt may be 90 to 500 pats by weight, based on 100 parts by weight of the copolymer.

The solvent is not particularly limited, but may include, for example, N,N-dimethylformamide (DMF).

For example, the polymer electrolyte membrane may be prepared by drying the composition at a temperature of about 60° C. to 100° C. for about 40 to 100 hours.

According to the present disclosure, a lithium secondary battery including the polymer electrolyte membrane is provided.

The lithium secondary battery may include a cathode, an anode disposed opposite to the cathode, and the polymer electrolyte membrane disposed between the cathode and the anode. The polymer electrolyte membrane physically separates the anode from the cathode, while also functioning as a migration medium for lithium ions.

The cathode may include a cathode current collector and a cathode active material layer disposed on at least one surface of the cathode current collector.

The cathode current collector may include stainless steel, nickel, aluminum, titanium, or an alloy thereof. The cathode current collector may also include aluminum or stainless steel whose surface is treated with carbon, nickel, titanium, or silver.

The cathode active material layer may include a cathode active material. The cathode active material may include a compound capable of reversibly intercalating and deintercalating lithium ions.

According to exemplary embodiments, the cathode active material may include a lithium-nickel metal oxide. The lithium-nickel metal oxide may further include at least one of cobalt (Co), manganese (Mn) and aluminum (Al).

In some embodiments, the cathode active material or the lithium-nickel metal oxide may include a layered structure or a crystal structure represented by Formula 8 below.

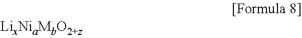

In Formula 8, x, a, b and z may satisfy 0.9≤x≤1.2, 0.6≤a≤0.99, 0.01≤b≤0.4, and −0.5≤z≤0.1. As described above, M may include Co, Mn and/or Al.

The chemical structure represented by Formula 8 indicates a bonding relationship between elements included in the layered structure or the crystal structure of the cathode active material, and does not exclude other additional elements. For example, M includes Co and/or Mn, and Co and/or Mn may be provided as main active elements of the cathode active material together with Ni. Here, it should be understood that Formula 8 is provided to express the bonding relationship between the main active elements, and is a formula encompassing the introduction and substitution of additional elements.

In one embodiment, the cathode active material may further include auxiliary elements which are added to the main active elements, in order to enhance chemical stability thereof or the layered structure/crystal structure. The auxiliary element may be incorporated into the layered structure/crystal structure together with the main active elements to form bonds, and it should be understood that this case is also included within the chemical structure range represented by Formula 8.

The auxiliary element may include, for example, at least one of Na, Mg, Ca, Y, Ti, Hf, V, Nb, Ta, Cr, Mo, W, Fe, Cu, Ag Zn, B, Al, Ga, C, Si, Sn, Sr, Ba, Ra, P and Zr. The auxiliary element may serve as an auxiliary active element which contributes to the capacity/output activity of the cathode active material together with Co or Mn, such as Al.

For example, the cathode active material or the lithium-nickel metal oxide may include a layered structure or a crystal structure represented by Formula 8-1 below.

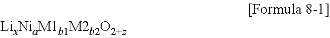

In Formula 8-1, M1 may include Co, Mn and/or Al. M2 may include the auxiliary elements described above. In Formula 8-1, x, a, b1, b2 and z may satisfy 0.9≤x≤1.2, 0.6≤a≤0.99, 0.01≤b1+b2≤0.4, and −0.5≤z≤0.1.

The cathode active material may further include a coating element or a doping element. For example, elements which are substantially the same as or similar to the above-described auxiliary elements may be used as the coating element or the doping element. For example, the above-described elements may be used alone or in combination of two or more thereof as the coating element or the doping element.

The coating element or the doping element may exist on the surface of the lithium-nickel metal oxide particles, or may penetrate through the surface of the lithium-nickel metal composite oxide particles to be incorporated into the bonding structure represented by Formula 8 or Formula 8-1 above.

The cathode active material may include a nickel-cobalt-manganese (NCM)-based lithium oxide. In this case, an NCM-based lithium oxide with an increased content of nickel may be used.

Nickel (Ni) may be provided as a transition metal associated with the output and capacity of the lithium secondary battery. Therefore, as described above, by employing a high-nickel-content (high-N) composition in the cathode active material, a high-capacity cathode and a high-capacity lithium secondary battery may be provided.

In this regard, as the content of Ni increases, long-term storage stability and cycle life stability of the cathode or the secondary battery may be relatively reduced, and side reactions with the electrolyte may also increase. However, according to exemplary embodiments, by including Co, the cycle life stability and capacity retention characteristics may be improved through Mn while maintaining electrical conductivity.

The content of Ni (e.g., the molar fraction of nickel based on the total molar amount of nickel, cobalt and manganese) in the NCM-based lithium oxide may be 0.6 or more, 0.7 or more, or 0.8 or more. In some embodiments, the content of Ni may be 0.8 to 0.95, 0.82 to 0.95, 0.83 to 0.95, 0.84 to 0.95, 0.85 to 0.95, or 0.88 to 0.95.

In some embodiments, the cathode active material may include a lithium cobalt oxide-based active material, a lithium manganese oxide-based active material, a lithium nickel oxide-based active material, or a lithium iron phosphate (LFP)-based active material (e.g., LiFePO₄).

In some embodiments, the cathode active material may include, for example, a manganese (Mn)-rich active material, a lithium (Li)-rich layered oxide (LLO)/over-lithiated oxide (OLO)-based active material, or a cobalt (Co)-less active material, which has a chemical structure or a crystal structure represented by Formula 9.

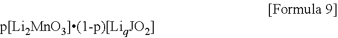

In Formula 9, p and q may satisfy 0<p<1, and 0.9≤q≤1.2, and J may include at least one element selected from Mn, Ni, Co, Fe, Cr, V, Cu, Zn, Ti, Al, Mg and B.

The cathode active material layer may further include a binder or a conductive material. The binder may bind cathode active material particles together and improve the adhesion between the cathode current collector and the cathode active material layer, and the conductive material may improve the electrical conductivity of the cathode active material layer.

The binder may include polyvinylidene fluoride (PVDF), poly(vinylidene fluoride-co-hexafluoropropylene), polyacrylonitrile, polymethylmethacrylate, acrylonitrile butadiene rubber (NBR), polybutadiene rubber (BR), styrene-butadiene rubber (SBR) and the like. In one embodiment, a PVDF-based binder may be used as the cathode binder.

The conductive material may include carbon-based conductive materials such as graphite, carbon black, acetylene black, Keen black, graphene, carbon nanotubes, vapor-grown carbon fibers (VGCFs), and carbon fibers, and/or metal-based conductive materials, including perovskite materials, such as tin, tin oxide, titanium oxide, LaSrCoO₃, and LaSrMnO₃, but it is not limited thereto.

According to exemplary embodiments, a cathode active material layer may be formed on the cathode current collector using a cathode slurry including the cathode active material. The cathode slurry may include the cathode active material and a solvent, and may further include a binder and/or a conductive material.

The solvent may include N-methyl-2-pyrrolidone (NMP), dimethylformamide, dimethylacetamide, N,N-dimethylaminopropylamine, ethylene oxide, tetrahydrofuran and the like. These may be used alone or in combination of two or more thereof.

The cathode slurry may further include a thickener and/or dispersant. In one embodiment, the cathode slurry may include a thickener such as carboxymethyl cellulose (CMC).

The cathode slurry may be applied to one surface of the cathode current collector, followed by drying and roll-pressing to form a cathode active material layer. The application may be performed using methods such as gravure coating slot die coating simultaneous multilayer die coating imprinting doctor blade coating dip coating bar coating or casting etc., but it is not limited thereto.

The anode may include an anode current collector and an anode active material layer disposed on at least one surface of the anode current collector. Alternatively, the anode may include a lithium metal layer.

The anode current collector may include a copper foil, a nickel foil, a stainless steel foil, a titanium foil, a nickel foam, a copper foam, a polymer substrate coated with a conductive metal and the like.

The anode active material layer may include an anode active material. As the anode active material, a material capable of adsorbing and desorbing lithium ions may be used. For example, as the anode active material, carbon-based materials such as crystalline carbon, amorphous carbon, carbon composites, or carbon fibers, etc.; lithium metal; a lithium alloy; a silicon (Si)-containing material or a tin (Sn)-containing material may be used.

Examples of the amorphous carbon may include hard carbon, soft carbon, coke, mesocarbon microbead (MCMB), mesophase pitch-based carbon fiber (MPCF) or the like.

Examples of the crystalline carbon may include graphite-based carbon such as natural graphite, artificial graphite, graphitized coke, graphitized MCMB, graphitized MPCF or the like.

The anode active material layer may include a lithium metal-containing layer. In one embodiment, a lithium metal-containing layer deposited or coated on the anode current collector may be used as the anode active material layer. In one embodiment, a lithium thin film layer may be used as the anode active material layer. The lithium metal-containing layer may include a lithium alloy or may be composed only of lithium metal.

Elements included in the lithium alloy may include aluminum, zinc, bismuth, cadmium, antimony, silicon, lead, tin, gallium, or indium, etc.

The anode may include a lithium metal layer. In this case, the anode may not include an anode current collector. For example, the anode may include a lithium foil.

According to exemplary embodiments, an anode active material layer may be formed on the anode current collector using an anode slurry including the anode active material. The anode slurry may include the anode active material and a solvent, and may further include a binder and/or a conductive material.

The solvent may include water, purified water, deionized water, distilled water, ethanol, isopropanol, methanol, acetone, n-propanol, t-butanol, etc.

The above-described materials that can be used when manufacturing the cathode as the binder, conductive material and thickener may also be used for the anode.

In some embodiments, a styrene-butadiene rubber (SBR)-based binder, carboxymethyl cellulose (CMC), polyacrylic acid-based binder, poly(3,4-ethylenedioxythiophene) (PEDOT)-based binder, and the like may be used as an anode binder.

The anode slurry may be applied to one surface of the anode current collector, followed by drying and roll-pressing to form an anode active material layer. The application may be performed using methods such as gravure coating slot die coating simultaneous multilayer die coating imprinting doctor blade coating dip coating bar coating or casting etc., but it is not limited thereto.

In some embodiments, the anode may be prepared in the form of a lithium foil. Alternatively, the anode may be fabricated by forming a lithium metal layer on at least one surface of the anode current collector through electrodeposition, plating or deposition.

According to exemplary embodiments, the cathode, the polymer electrolyte membrane, and the anode may be sequentially and repeatedly disposed to form an electrode assembly. In some embodiments, the electrode assembly may be a winding type, a stacking type, a z-folding type, or a stack-folding type.

The lithium secondary battery may include the electrode assembly accommodated in a case. The case may be a pouch type case, a prismatic case, a cylindrical case, a coin-type case or the like.

Hereinafter, the embodiments of the present disclosure will be further described with reference to specific experimental examples. The examples and comparative examples included in the experimental examples are merely illustrative of the present disclosure and do not limit the scope of the appended claims. It will be apparent to those skilled in the art that various changes and modifications to the examples can be made within the scope and technical spirit of the present disclosure, and it is also understood that such changes and modifications fall within the scope of the appended claims.

### Synthesis Example 1

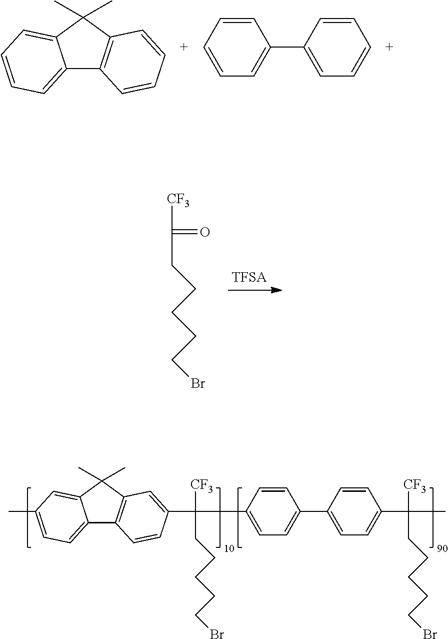

9,9-dimethylfluorene (1 g 5.15 mmol), biphenyl (7.14 g 46.33 mmol), and 7-bromo-1,1,1-trifluoroheptan-2-one (13.99 g 56.62 mmol) were used as monomers, trifluoromethanesulfonic acid (TFSA) (77.25 g 514.75 mmol) was used as a catalyst, and 23 parts by weight of dichloromethane (DCM), based on 100 pats by weight of total monomers, was used as a reaction solvent. These were mixed, and the mixture was maintained at 5° C. for 30 minutes and then reacted at room temperature (25° C.) for 3 hours and 30 minutes to synthesize a copolymer.

After the reaction, the dispersion including the copolymer was precipitated in methanol (1300 ml), washed several times with methanol, and then dried in a vacuum oven at 40° C. to obtain the copolymer.

### Synthesis Example 2

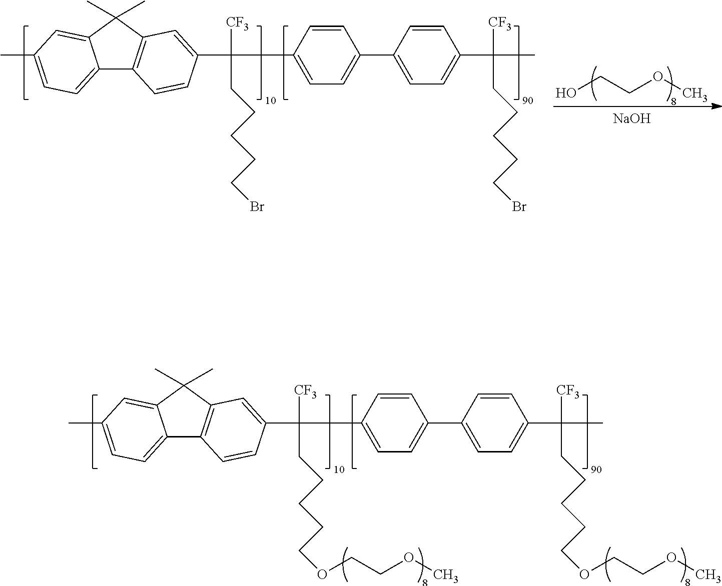

The copolymer (2 g 5.16 mmol) of Synthesis Example 1 and poly(ethylene glycol) methyl ether 400 (6.20 g, 15.4 mmol) having eight polyethylene oxide repeating units were used as reactants, NaOH (0.62 g 15.49 mmol) was used as a catalyst, and 17 parts by weight of dimethylacetamide (DMAc), based on 100 pats by weight of total reactants, was used as a reaction solvent. These were mixed, and the mixture was maintained at 70° C. for 1 hour and then reacted at 130° C. for 3 hours to synthesize a copolymer (weight average molecular weight: 200 to 250 kg/mol, polydispersity index (PDI): 3).

After the reaction, the dispersion including the copolymer was precipitated in distilled water, washed several times with distilled water, and then dried in an oven at 40° C. to obtain the copolymer.

### Experimental Example 1: Confirmation of Copolymer Structure

### (1) ¹H-NMR Analysis

The ¹H-NMR results of the copolymers of Synthesis Examples 1 and 2 were confirmed.

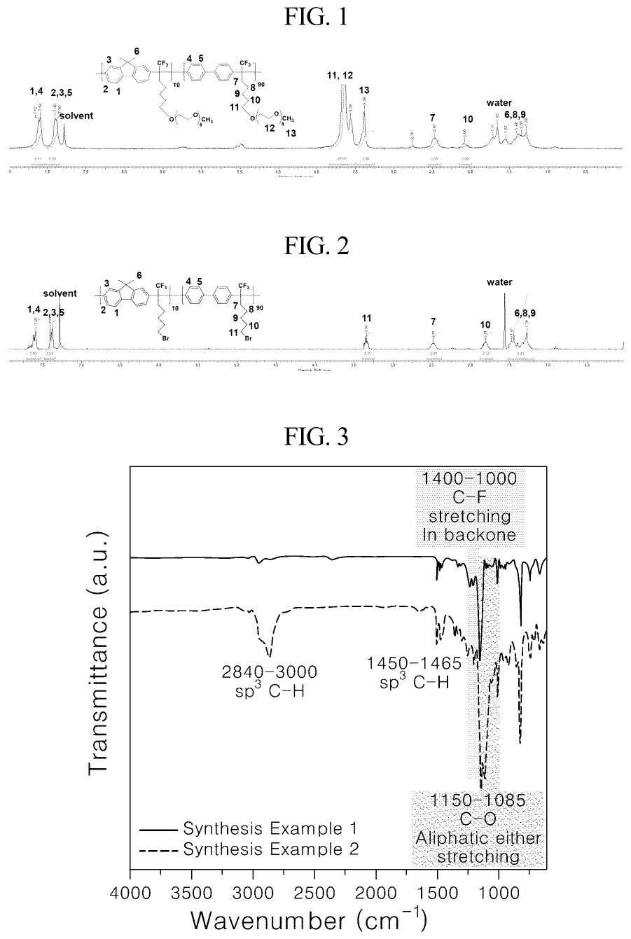

FIGS. 1 and 2 are graphs showing the ¹H-NMR results of the copolymers of Synthesis Examples 2 and 1, respectively. Analysis was performed on dispersions including the copolymers and solvent, using CDCl₃ as the solvent.

Referring to FIGS. 1 and 2, peaks (7 to 8 ppm) derived from the phenyl groups of the polymer main chain and peaks (1 to 3.5 ppm) derived from the alkylene Linker and the methyl groups of fluorene, which connect the polymer segments in the side chains to the main chain, were observed in the copolymers of Synthesis Examples 1 and 2.

Additionally, the peak intensity derived from the methylene group (carbon 11) bonded to Br in the copolymer of Synthesis Example 1 changed in the spectrum of the copolymer of Synthesis Example 2, and the peaks derived from carbons 12 and 13 of the polyether segment introduced into the copolymer of Synthesis Example 2 exhibited higher intensities. Integration of the peaks derived from carbon 11 and the peaks derived from carbons 12 and 13 confirmed that the copolymer of Synthesis Example 1 was converted into the copolymer of Synthesis Example 2 at a conversion rate of 77 mol %.

### (2) FT-IR Analysis

The FT-IR analysis results of the copolymers of Synthesis Examples 1 and 2 were confirmed.

FIG. 3 is a graph showing the FT-IR analysis results of the copolymers of Synthesis Examples 1 and 2.

Referring to FIG. 3, the analysis results for the copolymer of Synthesis Example 2 exhibited peaks derived from ethylene and methyl groups in the polyether segment (1450 to 1465 cm⁻¹, 2840 to 3000 cm⁻¹) and peaks derived from carbon-oxygen bonds (1085 to 1150 cm⁻¹).

### Experimental Example 2: Evaluation of Thermal Stability of Copolymer

### (1) Differential Scanning Calorimetry (DSC) Analysis

The copolymers of Synthesis Examples 1 and 2 were heated from room temperature (25° C.) to 120° C. at a rate of 20° C./min and maintained at 120° C. for 1 minute. The temperature was then decreased to −70° C. at a rate of 20° C./min and maintained for 10 minutes to stabilize.

The temperature was then increased to 120° C. at a rate of 20° C./min, and the glass transition temperature (Tg) of the copolymers was measured under a nitrogen atmosphere.

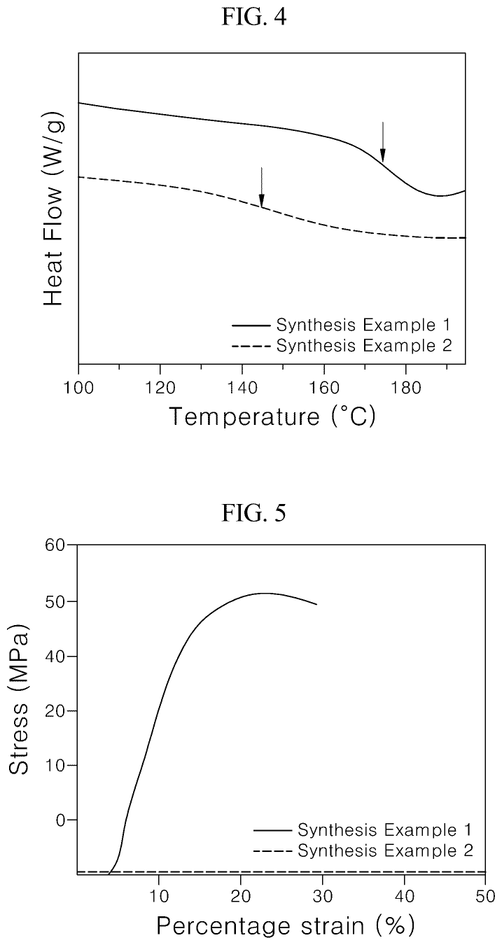

FIG. 4 is a graph showing the DSC analysis results of the copolymers of Synthesis Examples 1 and 2.

Referring to FIG. 4, the inflection points (indicated by arrows) in the DSC curves were identified as the glass transition temperatures. The copolymer of Synthesis Example 1 had a glass transition temperature of 177.9° C., and the copolymer of Synthesis Example 2 had a glass transition temperature of 148.9° C. The copolymer of Synthesis Example 2 exhibited improved flexibility compared to the copolymer of Synthesis Example 1 while maintaining appropriate thermal stability.

### (2) Thermogravimetric Analysis (TGA)

For the copolymers of Synthesis Examples 1 and 2, and for reference, polyethylene glycol (mPEG), the temperature was increased from room temperature (25° C.) to 120° C. at a rate of 20° C./min and maintained at 120° C. for 10 minutes to remove residual moisture and stabilize.

The temperature was then decreased to 60° C. at a rate of 20° C./min and subsequently increased from 60° C. to 800° C. at a rate of 10° C./min. The weight change of the copolymer was measured under a nitrogen atmosphere, and thermogravimetric analysis (TGA) was performed.

As a result of the analysis, the 5 wt % decomposition temperature (the point at which the weight decreased to 95 wt %/o) of the copolymer of Synthesis Example 2 was 331.4° C., and the 5 wt % decomposition temperature of the copolymer of Synthesis Example 1 was 338.2° C. The thermal stability of the copolymer of Synthesis Example 1 was higher than that of the copolymer of Synthesis Example 2.

### Experimental Example 3: Evaluation of Mechanical Properties of Copolymer

ASTM D 638 type V specimens (dog-bone shape) were prepared using the copolymers of Synthesis Examples 1 and 2.

The specimens were mounted on a LLOYD UTM LS1 instrument equipped with a 250 N load cell.

Five specimens prepared using the copolymer of Synthesis Example 1 were stretched at a rate of 5 mm/min to obtain strain-stress curves. The tensile strength and elongation at break were then determined.

Five specimens prepared using the copolymer of Synthesis Example 2 were stretched at a strain rate of 50 mm/min to obtain strain-stress curves. The tensile strength and elongation at break were then determined.

The tensile strength and elongation at break were calculated as the average and standard deviation, respectively, for the five specimens.

FIG. 5 shows the strain-stress curves of the copolymers of Synthesis Examples 1 and 2.

Referring to FIG. 5, the copolymer of Synthesis Example 1 had a tensile strength of 31.8±5.4 MPa and an elongation at break of 49.8±2.0%. In contrast, the copolymer of Synthesis Example 2 had a tensile strength of 1.1±0.4 Mpa and an elongation at break of 1574.0±279.0%. Therefore, the copolymer of Synthesis Example 2 exhibited low tensile strength and high elongation at break, thereby providing improved flexibility. More specifically, it had a tensile strength that was significantly lower than that of the copolymer of Synthesis Example 1, while exhibiting an elongation at break that was significantly higher than that of the copolymer of Synthesis Example 1.

### Examples 1 to 4: Preparation of Polymer Electrolyte Membrane

0.1 g of the polymer of Synthesis Example 2 was added to a 10 mL vial and mixed with 2 mL of N,N-dimethylformamide (DMF). The polymer was then thoroughly dispersed in a stirrer at 80° C. to prepare a polymer dispersion.

A lithium salt solution was prepared by dissolving 0.1 g 0.15 g 0.23 g, or 0.4 g of lithium bis(fluorosulfonyl)imide (LiFSI) in 1 mL of DMF in a 2 mL vial.

While stirring the polymer dispersion, the lithium salt solution was added dropwise using a syringe to prepare a polymer electrolyte membrane composition containing 50 wt %, 60 wt %, 70 wt %, or 80 wt % of lithium salt based on the solid content.

To facilitate separation after membrane formation, the polymer electrolyte membrane composition was poured into polytetrafluoroethylene (PTFE) Petri dishes and dried in a vacuum oven at 80° C. for 48 to 96 h to prepare polymer electrolyte membranes of Examples 1 to 4 having a thickness of about 30 m to 40 μm.

The manufacturing process was performed in a glove box.

### Comparative Example 1

When using the polymer of Synthesis Example 1, the polymer exhibited deteriorated properties, making it impossible to prepare a polymer electrolyte membrane using the same method as in the examples.

### Experimental Example 4: Evaluation of Thermal Stability of Electrolyte Membranes

The weight change of the polymer electrolyte membranes of the examples was measured by thermogravimetric analysis (TGA) while increasing the temperature from room temperature (25° C.) to 800° C. at a rate of 10° C./min under a nitrogen atmosphere.

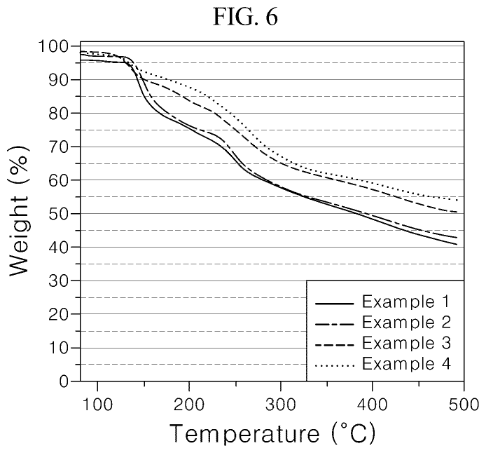

FIG. 6 shows the TGA analysis results of the polymer electrolyte membranes of Examples 1 to 4.

### Experimental Example 5: Evaluation of Ionic Conductivity of Electrolyte Membranes

The bulk impedance of the electrolyte membrane was measured using electrochemical impedance spectroscopy (EIS), and the ionic conductivity was then determined.

Specifically, for impedance measurement, the polymer electrolyte membranes of the examples were cut into circular specimens with a diameter of 1.9 cm. A 2023 coin cell was assembled in a symmetrical configuration with stainless steel electrodes placed on both sides of the electrolyte membrane. Measurements were performed using an electrochemical workstation (SP-150, ProDigitek, Australia).

The measurement conditions were as follows: impedance was measured by varying the frequency of the AC current from 1.00 MHz to 0.1 Hz at room temperature (25° C.), and the ionic conductivity was calculated using the following equation:

$$Ionic conductivity ( σ ) [ S {cm}^{- 1} ] = L / ( R \times S ) \qquad [ Formula ]$$

In the equation, L is the thickness of the polymer electrolyte membranes, R is the bulk resistance, and S is the area of the SUS blocking electrode (diameter: 15 mm) used in coin cell fabrication.

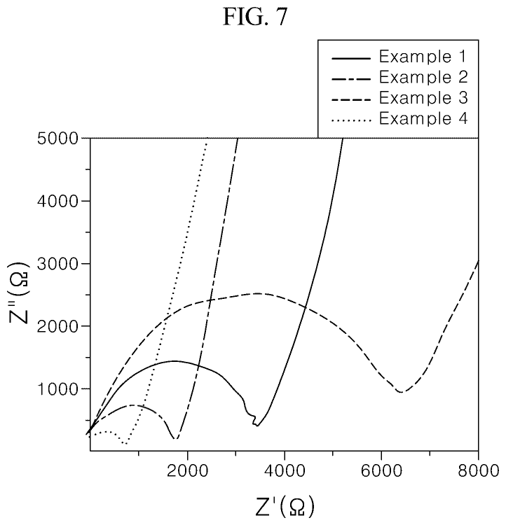

FIG. 7 shows the EIS results of the polymer electrolyte membranes of Examples 1 to 4.

Table 1 below shows the ionic conductivities of the polymer electrolyte membranes of the examples.

TABLE 1

| | Ionic conductivity |
|---|---|
| | (10⁻⁶ × S/cm) |
| Example 1 | 0.7065 |
| Example 2 | 1.2553 |
| Example 3 | 2.93 |
| Example 4 | 2.1568 |

Referring to FIG. 7 and Table 1, the ionic conductivity of the polymer electrolyte membranes of the examples was improved.

In particular, the ionic conductivity of the polymer electrolyte membranes of Examples 2 and 3, which included appropriate ratios of the polymer and lithium salt, was higher.

The contents described above are merely examples of applying the principles of the present disclosure, and other configurations may be further included without departing from the scope of the present disclosure.

1. A polymer electrolyte membrane for a lithium secondary battery comprising a copolymer, the copolymer comprising:
a main chain comprising a first repeating unit represented by Formula 1 below and a second repeating unit represented by Formula 2 below;
a fluoroalkyl group bonded as a side chain to the main chain; and
a polymer segment bonded as a side chain to the main chain and containing oxygen: 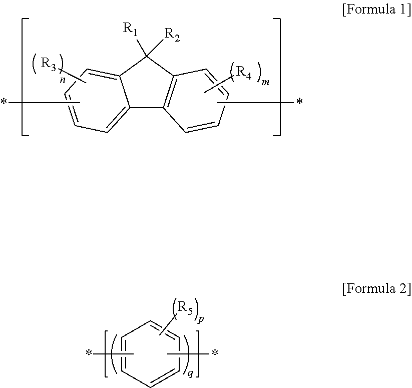
(in Formulas 1 and 2, R₁ and R₂ are each independently hydrogen or an alkyl group having 1 to 10 carbon atoms,
R₃ to R₅ are each independently hydrogen, an alkyl group having 1 to 60 carbon atoms, an alkenyl group having 2 to 60 carbon atoms, an alkynyl group having 2 to 60 carbon atoms, or an arylthioxy group having 6 to 60 carbon atoms,
n, m and p are each independently 0 or an integer from 1 to 4,
q is an integer from 2 to 4, and
* represents a bonding site).

2. The polymer electrolyte membrane for a lithium secondary battery according to claim 1, wherein Formula 1 is represented by Formula 1-1 below:

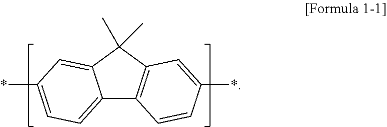

3. The polymer electrolyte membrane for a lithium secondary battery according to claim 1, wherein the Formula 2 is represented by Formula 2-1 or 2-2 below:

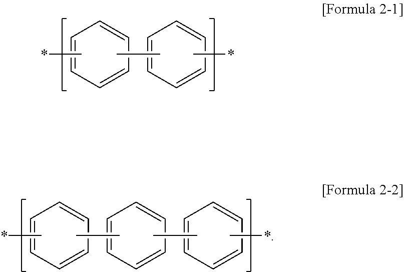

4. The polymer electrolyte membrane for a lithium secondary battery according to claim 1, wherein the ratio of the number of the second repeating units to the number of the first repeating units is 0.1 to 10.

5. The polymer electrolyte membrane for a lithium secondary battery according to claim 1, wherein the fluoroalkyl group has a structure in which at least one of the hydrogen atoms of the alkyl group having 1 to 10 carbon atoms is substituted with fluorine.

6. The polymer electrolyte membrane for a lithium secondary battery according to claim 1, wherein the fluoroalkyl group comprises at least one selected from the group consisting of a trifluoromethyl group, a pentafluoroethyl group, a trifluoroethyl group, and a heptafluoropropyl group.

7. The polymer electrolyte membrane for a lithium secondary battery according to claim 1, wherein the fluoroalkyl group is directly bonded to the main chain.

8. The polymer electrolyte membrane for a lithium secondary battery according to claim 1, wherein the polymer segment comprises a polyether segment or a poly(meth)acrylate segment.

9. The polymer electrolyte membrane for a lithium secondary battery according to claim 8, wherein the polyether segment is represented by Formula 3 below: 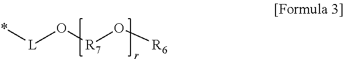
(in Formula 3, L is a direct bond or an alkylene group having 1 to 10 carbon atoms, R₆ is an alkyl group having 1 to 10 carbon atoms, R₇ is an alkylene group having 1 to 10 carbon atoms, r is an integer from 5 to 20, and * represents a bonding site to the main chain).

10. The polymer electrolyte membrane for a lithium secondary battery according to claim 1, wherein the main chain comprises a third repeating unit represented by Formula 4 below: 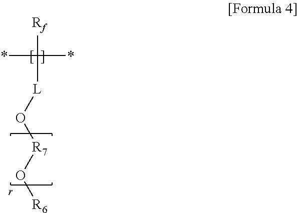
(in Formula 4, R_{f} is a fluoroalkyl group having 1 to 10 carbon atoms, L is a direct bond or an alkylene group having 1 to 10 carbon atoms, R₆ is an alkyl group having 1 to 10 carbon atoms, R₇ is an alkylene group having 1 to 10 carbon atoms, r is an integer from 5 to 20, and * represents a bonding site).

11. The polymer electrolyte membrane for a lithium secondary battery according to claim 1, wherein the copolymer has a weight average molecular weight of 10 kg/mol to 400 kg/mol.

12. The polymer electrolyte membrane for a lithium secondary battery according to claim 1, wherein the polymer electrolyte membrane has a thickness of 20 μm to 100 μm.

13. The polymer electrolyte membrane for a lithium secondary battery according to claim 1, wherein the polymer electrolyte membrane has an ionic conductivity of 0.2×10⁻⁶ S/cm to 100×10⁻⁶ S/cm.

14. The polymer electrolyte membrane for a lithium secondary battery according to claim 1, wherein the polymer electrolyte membrane for a lithium secondary battery comprises a lithium salt, and
the content of the lithium salt is 50% by weight to 90% by weight, based on the total weight of the polymer electrolyte membrane for a lithium secondary battery.

15. A lithium secondary battery comprising:
a cathode;
an anode disposed opposite to the cathode; and
the polymer electrolyte membrane for a lithium secondary battery according to claim 1 disposed between the cathode and the anode.
